(19) United States
(12) Patent Application Publication
(10) Pub. No.: US 2009/0300105 A1
(43) Pub. Date: Dec. 3, 2009

(54) SYSTEM AND METHOD FOR COMMUNICATION CONNECTION IN NETWORK ARCHITECTURE

(75) Inventors: CHIH-YI CHEN, TAIPEI (TW); HSIEN-KANG WANG, TAIPEI (TW); SHIH-HUA YU, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: ASUSTEK COMPUTER INC., TAIPEI (TW)

(21) Appl. No.: 12/425,834

(22) Filed: Apr. 17, 2009

(30) Foreign Application Priority Data
Jun. 2, 2008 (TW) 097120401

(51) Int. Cl. G06F 15/16

(52) U.S. Cl. 709/203; 709/223; 709/230; 726/11; 709/204

(57) ABSTRACT

A system and method for a communication connection in network architecture are provided. First, a client terminal is linked to a target terminal via the Internet. Then whether the link mode is a virtual link or a substantial link is determined. If the link mode is the substantial link, the client terminal is communicationally connected to the target terminal via the substantial link. If the link mode is the virtual link, whether a local area network is linked via a STUN server is determined. If yes, a peer-to-peer link is built via the STUN server. If no, the client terminal is communicationally connected to a management server of the local area network, and then the management server is communicationally connected to the target terminal.

### BACKGROUND OF THE INVENTION

1. Field of the Invention

The invention relates to a system and method for a communication connection in network architecture and, more particularly, to a system and method for a communication connection in network architecture used to determine a link mode.

2. Description of the Related Art

The development of the Internet brings convenience of information transmission. For being connected with the Internet, each terminal needs to use an Internet protocol (IP) address to define a position to facilitate downloading and uploading of data.

In recent years, with the rapid development of the Internet, the data can be exchanged remotely in a peer-to-peer mode. Thus, the peer-to-peer mode becomes popular. For example, a remote desktop control application can utilized a peer-to-peer link to make a terminal connect with another terminal via the Internet and to recover or help maintain the system of the other terminal.

There is no problem to use a physical IP address to perform the peer-to-peer link. However, when the terminal needing to be linked is located at a virtual IP address, it is troublesome. In the prior art, many techniques relate to a communication connection of the virtual IP address. For example, in the prior art, when a terminal behind a firewall needs to be linked, a tunnel is built in the firewall, and a specific port is used to connect. A management server is disposed in the local area network behind the firewall. In the management server, all linked terminals of the local area network correspond to different management accounts, respectively. The management server is used to allow the terminal outside the firewall to be communicationally connected to the terminals needing a communication connection in the local area network through the tunnel of the firewall via the management accounts.

However, when a terminal of the Internet is to be connected to another terminal and the link mode of the other terminal is not known, in the prior art, no matter what the link mode is, a same principle is used to link. For example, when a physical IP address is used to make a communication connection, once the other terminal needing to be linked is located at a virtual IP address, the connection cannot be realized.

Furthermore, if a communication connection is realized by a virtual link, the linked address is transmitted to a management server and the aforementioned method is used to link. However, if the management server is responsible for all link work, a large amount of system resource may be wasted, and thus the system cannot load too much work.

Therefore, the main object of the invention is to provide a system and method for a communication connection in network architecture used to determine the link mode to improve the prior art.

### BRIEF SUMMARY OF THE INVENTION

The present invention provides a system and method for a communication connection in network architecture. An effective peer-to-peer link mode no matter a physical mode or different kinds of virtual link modes can be used to communicationally connect a client terminal and a target terminal, such as a remote desktop control application.

The invention relates to a system and method for a communication connection in network architecture. The network architecture includes the Internet, a client terminal, and a target terminal. In the method for the communication connection, first, the client terminal is linked to the target terminal via the Internet. The link mode is one of the groups including a substantial link and a virtual link.

Afterwards, whether the link mode is the substantial link or the virtual link is determined. If the link mode is determined to be the substantial link, the client terminal is communicationally connected to the target terminal through the substantial link.

If the link mode is determined to be the virtual link, the target terminal is in a local area network, and whether the local area network is linked via a simple traversal of user datagram protocol through network address translator (STUN) server is determined. The STUN server utilizes a network address translation (NAT) to designate a physical Internet protocol (IP) address and a port which a virtual IP address of the target terminal corresponds to.

When the local area network is determined to be linked via the STUN server, the client terminal establishes a peer-to-peer link via the STUN server, and it is connected to the target terminal.

When the local area network is determined not to be linked via the STUN server, the client terminal is communicationally connected to a management server of the local area network, and then the management server is communicationally connected to the target terminal.

Therefore, according to the system and method for the communication connection in the network architecture of the invention, a link determination module is used to sequentially determine the link mode of the Internet. The client terminal can be communicationally connected to the target terminal in an effective peer-to-peer link mode no matter a physical mode or different kinds of virtual link modes, such as a remote desktop control application.

These and other features, aspects, and advantages of the present invention will become better understood with regard to the following description, appended claims, and accompanying drawings.

### BRIEF DESCRIPTION OF THE DRAWINGS

FIG. 1 is a schematic diagram of network architecture where a system for a communication connection is located according to an embodiment of the invention;

FIG. 2 is a schematic diagram of a system for a communication connection according to an embodiment of the invention;

FIG. 3 is a schematic diagram showing how to determine whether a link is a virtual link according to an embodiment of the invention;

FIG. 4 is a schematic diagram showing a link via a STUN server according to an embodiment of the invention;

FIG. 5 is a schematic diagram of a management server according to an embodiment of the invention; and

FIG. 6 is a flowchart of a method for a communication connection according to an embodiment of the invention.

### DETAILED DESCRIPTION OF THE EMBODIMENTS

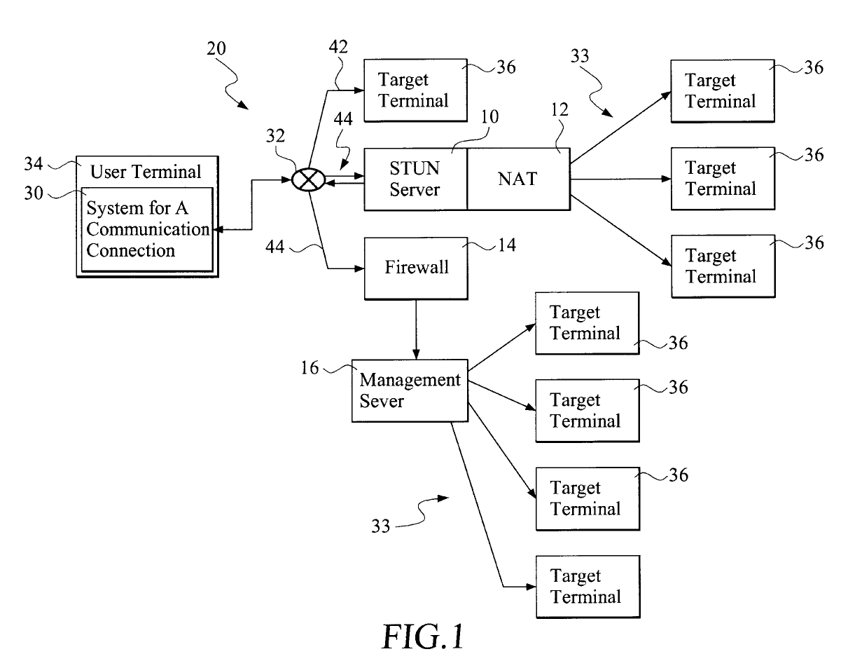

FIG. 1 is a schematic diagram of network architecture 20 where a system for a communication connection 30 is located according to an embodiment of the invention. As shown in FIG. 1, the invention relates to the system for the communication connection 30 in the network architecture 20. The network architecture 20 includes the Internet 32, a client terminal 34, and a target terminal 36 needing to be linked. The system for the communication connection 30 is disposed in the client terminal 34.

The client terminal 34 needs to be linked to the target terminal 36 via the Internet 32. The link mode may be a substantial link 42 or a virtual link 44. As far as the virtual link 44, at that moment, the target terminal 36 is in a local area network 33, and the local area network 33 where the target terminal 36 is located may be linked to the Internet 32 via a simple traversal of user datagram protocol through network address translators (STUN) server 10. The local area network 33 where the target terminal 36 is located also may be linked to the Internet 32 via a firewall 14 or an Internet protocol (IP) sharer.

The STUN server 10 utilizes a network address translation (NAT) 12 to designate a virtual IP address of each target terminal 36 of the local area network 33. The local area network behind the firewall 14 or the IP sharer can further include a management server 16, and the management server 16 is used to manage the target terminal 36 of the local area network 33.

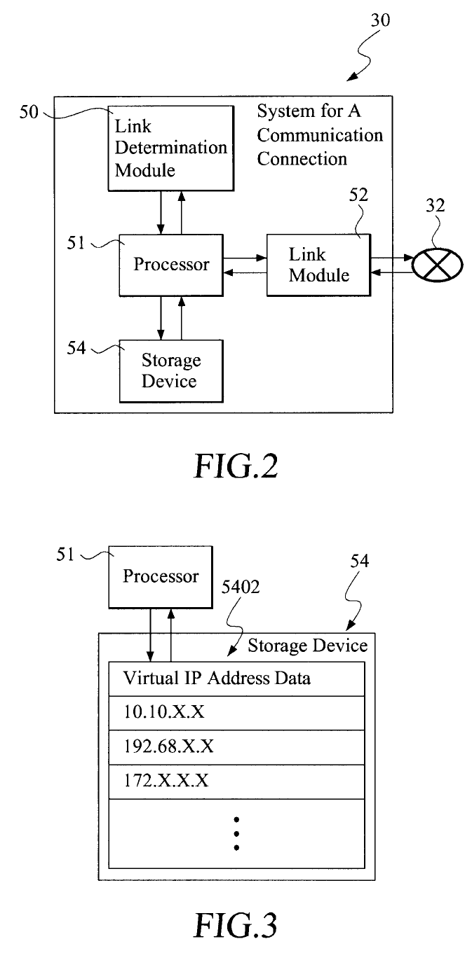

As shown in FIG. 1 and FIG. 2, FIG. 2 is a schematic diagram of the system for the communication connection 30 according to an embodiment of the invention. The system for the communication connection 30 further includes a processor 51, a link module 52, a link determination module 50, and a storage device 54.

The link module 52 is, for example, a network card. The client terminal 34 utilizes the link module 52 to be linked to the target terminal 36 via the Internet 32.

As shown in FIG. 2 and FIG. 3, FIG. 3 is a schematic diagram showing how to determine whether a link is a virtual link 44 according to an embodiment of the invention. The link determination module 50 is used to determine whether the link mode is a substantial link 42 or the virtual link 44. The link determination module 50 utilizes the link module 52 to be linked to the remote target terminal 36 of the Internet 32 via the processor 51 thus to obtain a linked IP address. The link determination module 50 further compares virtual IP address data 5402 stored in the storage device 54 beforehand with the linked IP address via the processor 51 in the storage device 54. The virtual IP address has a certain characteristic. As shown in FIG. 3, to take IPv4 as an example, the prior two codes may be 10.10 or 192.68. Thereby, the IP address is a virtual IP address.

Therefore, the link determination module 50 determines whether the link mode is the substantial link 42 or the virtual link 44 by comparing the IP address linked by the link module 52 with the virtual IP address data 5402 of the storage device 54 to determine whether they conform to each other via the processor 51. If the IP address conforms to the virtual IP address data 5402, the link mode is a virtual link 44. If the IP address does not conform to the virtual IP address data 5402, the link mode is a substantial link 42.

When the link determination module 50 determines that the link mode is the substantial link 42, the link module 52 is directly communicationally connected to the target terminal 36 via the substantial link 42.

When the link determination module 50 determines that the link mode is the virtual link 44, the link determination module 50 further determines whether the local area network 33 is linked via a STUN server 10. The STUN server 10 is generally called as a simple traversal of user datagram protocol through network address translators (STUN) server.

When the link determination module 50 determines that the local area network 33 is linked via the STUN server 10, the link module 52 corresponds to the virtual IP address designated by the NAT 12 to be communicationally connected to the target terminal 36. Finally, when the link determination module 50 determines that the local area network 33 is not linked via the STUN server 10, it supposes that the local area network 33 is linked to the Internet 32 via the firewall 14 or the IP sharer, the link module 52 is communicationally connected to the management server 16 of the local area network 33, and then the management server 16 is communicationally connected to the target terminal 36.

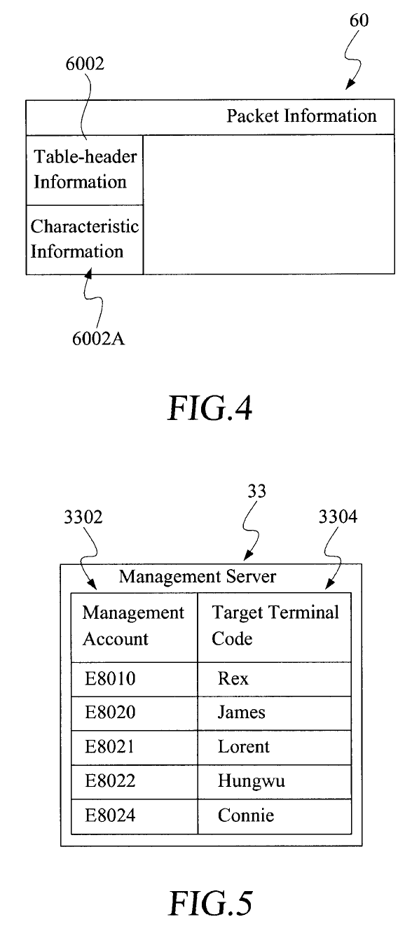

As shown in FIG. 2 and FIG. 4, FIG. 4 is a schematic diagram showing a link via the STUN server 10 according to an embodiment of the invention. The link determination module 50 determines whether the local area network 33 is linked via the STUN server 10. After the link module 52 is linked to the target terminal 36 via the Internet 32, the link determination module 50 interprets packet information 60 responded by the STUN server 10 to the link module 52 via the processor 51. When table-header information 6002 of the packet information 60 has characteristic information 6002A corresponding to the STUN server 10, the link determination module 50 determines that the local area network 33 is linked via the STUN server 10. Furthermore, in light of the additional information, network addresses and ports (that is the characteristic information 6002A), provided by the mapped-address of the table-header information 6002 of the packet information 60, after a logic comparison, whether to support the STUN server 10 is determined. If the STUN server 10 is determined to be supported, the link determination module 50 determines that the local area network 33 is linked via the STUN server 10.

In addition, as shown in FIG. 5, FIG. 5 is a schematic diagram of the management server 16 according to an embodiment of the invention. As described in the aforementioned system for the communication connection 30, the management server 16 makes all target terminals 36 in the local area network 33 use different target terminal codes 3304 to correspond to different management accounts 3302, respectively, and the management server 16 is communicationally connected to the target terminals 36 represented by the target terminal codes 3304 via the management accounts 3302.

Furthermore, the link determination module 50 can utilize programming languages such as C, C++, Java, or python to cooperate with related electronic components and circuits to realize the functions performed by the aforementioned link determination module 50.

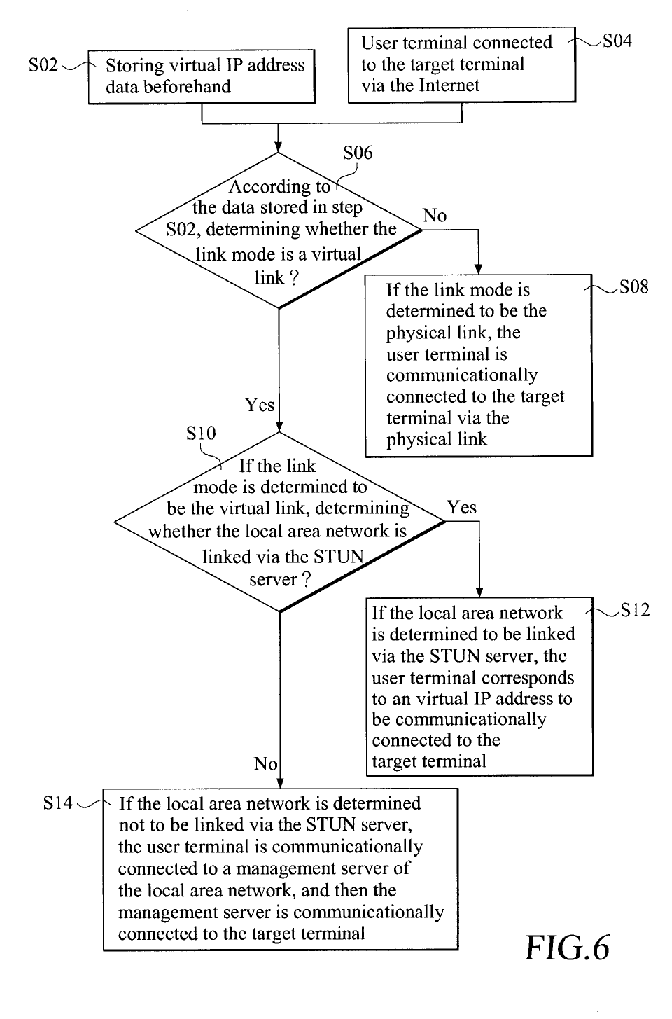

As shown in FIG. 6, FIG. 6 is a flowchart of a method for a communication connection according to an embodiment of the invention. The method for the communication connection is implemented in network architecture. The network architecture 20 includes the Internet 32, a client terminal 34, and a target terminal 36. The method for the communication connection includes the following steps.

In step S02, virtual IP address data 5402 are stored beforehand.

In step S04, first, the client terminal 34 is linked to the target terminal 36 via the Internet 32. The link mode is one of the groups including a substantial link 42 and a virtual link 44.

In step S06, then whether the link mode is the substantial link 42 or the virtual link 44 is determined. The method of determining the link mode is to compare the linked IP address with the virtual IP address data 5402 to determine whether they conform to each other. If the linked IP address conforms to the virtual IP address data 5402, the link mode is the virtual link 44. If the linked IP address does not conform to the virtual IP address data 5402, the link mode is the substantial link 42.

In step S08, if the link mode is determined to be the substantial link 42, the client terminal 34 is communicationally connected to the target terminal 36 through the substantial link 42.

In step S10, if the link mode is determined to be the virtual link 44, the target terminal 36 is in a local area network 33, and whether the local area network 33 is linked via a STUN server 10 is determined. The STUN server 10 uses a network address translation 12 to designate a virtual IP address of the target terminal 36.

The method of determining whether the local area network 33 is linked via the STUN server 10 is interpreting package information responded by the STUN server 10 to the client terminal 34 after the client terminal 34 is linked to the target terminal 36 via the Internet 32. When table-header information 6002 of the packet information 60 has characteristic information 6002A corresponding to the STUN server 10, the local area network 33 is determined to be linked via the STUN server 10.

In step S12, when the local area network 33 is determined to be linked via the STUN server 10, the client terminal 34 corresponds to the virtual IP address to be communicationally connected to the target terminal 36.

In step S14, after the local area network 33 is determined not to be linked via the STUN server 10, the local area network 33 is determined to be linked to the Internet 32 via the firewall 14 or the IP sharer. At that moment, the client terminal 34 is communicationally connected to the management server 16 of the local area network 33, and the management server 16 is communicationally connected to the target terminal 36.

Furthermore, the management server 16 makes all target terminals 36 of the local area network 33 correspond to different management accounts 3302, respectively, and the management server 16 is communicationally connected to the target terminals 36 via the management accounts 3302.

Therefore, according to the system for the communication connection 30 in the network architecture 20 and the method for the communication connection of the invention, the link determination module 50 is used to determine the link mode of the Internet 32 sequentially. The client terminal 34 can be communicationally connected to the target terminal 36 in an effective peer-to-peer link mode no matter a physical mode or different kinds of virtual link modes, such as a remote desktop control application.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for a communication connection in network architecture, wherein the network architecture includes the Internet, a client terminal, and a target terminal, the method for the communication connection comprising the steps of:
linking the client terminal to the target terminal via the Internet, wherein the link mode includes a substantial link and a virtual link; and
determining the link mode, wherein when the link mode is determined to be the substantial link, the client terminal is communicationally connected to the target terminal via the substantial link, and when the link mode is determined to be the virtual link, the target terminal is in a local area network, the client terminal is communicationally connected to a management server of the local area network, and then the management server is communicationally connected to the target terminal.

2. The method for the communication connection according to claim 1, wherein the method for the communication connection comprises the step of storing virtual Internet protocol (IP) address data for the determined link mode to compare the virtual IP address data with a linked IP address.

3. The method for the communication connection according to claim 2, wherein when the linked IP address conforms to the virtual IP address data, the link mode is the virtual link, and when the linked IP address does not conform to the virtual IP address data, the link mode is the substantial link.

4. The method for the communication connection according to claim 1, wherein after the step of determining that the link mode is the virtual link, the method for the communication connection further comprises the step of determining whether the local area network is linked via a simple traversal of user datagram protocol through network address translators (STUN) server.

5. The method for the communication connection according to claim 4, wherein the STUN server utilizes a network address translation (NAT) to designate a virtual IP address of the target terminal, when the local area network is determined to be linked via the STUN server, the client terminal corresponds to the virtual IP address to be communicationally connected to the target terminal, and when the local area network is determined not to be linked via the STUN server, the client terminal is communicationally connected to the management server of the local area network, and then the management server is communicationally connected to the target terminal.

6. The method for the communication connection according to claim 5, wherein the step of determining whether the local area network is linked via the STUN server is interpreting package information responded by the STUN server to the client terminal after the client terminal is linked to the target terminal via the Internet, and when table-header information of the packet information has characteristic information corresponding to the STUN server, the local area network is determined to be linked via the STUN server.

7. The method for the communication connection according to claim 1, wherein the management server makes all target terminals in the local area network correspond to different management accounts, respectively, and the management server is communicationally connected to the target terminal via the management account.

8. The method for the communication connection according to claim 1, wherein the local area network is linked via a firewall.

9. A system for a communication connection in network architecture, wherein the network architecture includes the Internet, a client terminal, and a target terminal, and the system for the communication connection is disposed in the client terminal, the system for the communication connection comprising:
a link module, wherein the client terminal utilizes the link module to be linked to the target terminal via the Internet, and the link mode includes a substantial link and a virtual link; and
a link determination module for determining whether the link mode is the substantial link or the virtual link;
wherein when the link determination module determines that the link mode is the substantial link, the link module is communicationally connected to the target terminal via the substantial link, and when the link determination module determines that the link mode is the virtual link, the target terminal is in a local area network, the link module is communicationally connected to a management server of the local area network, and then the management server is communicationally connected to the target terminal.

10. The system for the communication connection according to claim 9, wherein the system for the communication connection further comprises:
a storage device for storing virtual IP address data beforehand;
wherein the link determination module determines the link mode by comparing the IP address linked by the link module with the virtual IP address data in the storage device to determine whether they conform to each other, if the IP address linked by the link module conforms to the virtual IP address data in the storage device, the link mode is the virtual link, and if the IP address linked by the link module does not conform to the virtual IP address data in the storage device, the link mode is the substantial link.

11. The system for the communication connection according to claim 9, wherein after the link determination module determines that the link mode is the virtual link, the link determination module further determines whether the local area network is linked via a STUN server.

12. The system for the communication connection according to claim 11, wherein the STUN server utilizes a network address translation (NAT) to designate a virtual IP address of the target terminal, when the link determination module determines that the local area network is linked via the STUN server, the link module corresponds to the virtual IP address to be communicationally connected to the target terminal, and when the link determination module determines that the local area network is not linked via the STUN server, the link module is communicationally connected to the management server of the local area network, and the management server is communicationally connected to the target terminal.

13. The system for the communication connection according to claim 12, wherein the link determination module determines whether the local area network is linked via the STUN server by interpreting package information responded by the STUN server to the link module after the link module is linked to the target terminal via the Internet, and when table-header information of the packet information has characteristic information corresponding to the STUN server, the link determination module determines that the local area network is linked via the STUN server.

14. The system for the communication connection according to claim 9, wherein the management server makes all target terminals in the local area network correspond to different management accounts, and the management server is communicationally connected to the target terminal via the management account.

15. The system for the communication connection according to claim 9, wherein the local area network is linked via a firewall.
